(19) United States
(12) Patent Application Publication
(10) Pub. No.: US 2025/0116828 A1
(43) Pub. Date: Apr. 10, 2025

(54) OPTICAL MODULE

(71) Applicant: InnoLight Technology (Suzhou) Ltd., Suzhou , Jiangsu (CN)

(72) Inventors: Deng-Qun YU, Suzhou, Jiangsu (CN); YU-ZHOU SUN, Suzhou, Jiangsu (CN); XIAN-YAO LI, Suzhou City , Jiangsu Province (CN)

(21) Appl. No.: 18/724,488

(22) PCT Filed: Aug. 18, 2022
(86) PCT No.: PCT/CN2022/113313

§ 371 Date: Dec. 24, 2024

(30) Foreign Application Priority Data
Dec. 30, 2021 (CN) 202111654269.8

(51) Int. Cl. G02B 6/42

(52) U.S. Cl. CPC G02B 6/4214

(57) ABSTRACT

The present application discloses an optical module. The optical module comprises a housing, a circuit board arranged in the housing, an electric driving chip, a silicon optical chip, a laser, and a light guide device. The electric driving chip and the silicon optical chip are connected to a first surface of the circuit board; the laser is arranged on the surface of one side of the silicon optical chip away from the circuit board; the laser emits light and transmits the emitted light to the silicon optical chip; the light guide device guides the light emitted by the laser into the silicon optical chip. According to the present invention, the silicon optical chip capable of generating heat, a light source assembly, and the electric driving chip are located on the surface of the same side of the circuit board, such that a heat dissipation assembly can be arranged at a position on the same side of the circuit board, and therefore, heat dissipation in the optical module is facilitated, and centralized accumulation of heat in the optical module is avoided; in addition, no grooves need to be dug in the circuit board to contain a heat sink, the silicon optical chip, and the light source assembly, so that the utilization rate of the circuit board is improved, and the manufacturing cost is reduced.

### FIELD OF THE DISCLOSURE

The present disclosure relates to the technical field of optoelectronic device packaging technology, particularly to an optical module.

### BACKGROUND OF THE DISCLOSURE

In the fields of cloud computing, mobile internet, video, and other new business and application models, the optical communication technology is widely used. In the optical communication, optical modules are tools that realize the mutual conversion of optical and electrical signals, making them key components in optical communication devices. In these modules, utilizing silicon optical chips for optoelectronic conversion has become a mainstream approach for high-speed optical modules.

As shown in FIGS. 1 and 2, an optical module 90 in the prior art comprises a printed circuit board (PCB) 91. An electric driving chip 92 is arranged on the PCB 91. A groove is excavated on one side of the PCB 91 to house a silicon optical chip 93, and the silicon optical chip 93 is positioned on the same level as the PCB 91 and on a heat sink 94. The silicon optical chip 93 is connected to a fiber optic assembly 95 at the end away from the PCB 91. The fiber optic assembly 95 is connected to an interface part 96, and a plurality of light sources 97 are arranged on the heat sink 94 at a position corresponding to the silicon optical chip 93. The light sources 97 are on one side of the fiber optic assembly 95 to enable the light sources 97 to modulate signals onto the silicon optical chip 93 and transmit them through the fiber optic assembly 95. In general, the heat from the light sources 97 is quite concentrated and requires high-quality heat dissipation materials, so that a heat sink 94 is typically used. The silicon optical chip 93 is connected to the PCB 91 via gold wires 98. The silicon optical chip 93 is a high-speed device, making it highly sensitive to the length of the gold wire 98 connection, which needs to be as short as possible. Therefore, grooves are typically excavated on the PCB 91 to accommodate the heat sink 94, the silicon optical chip 93, and the light sources 97. However, this results in material waste from the PCB 91 and uneven placement of the heat sink 94 and electric driving chip 92, potentially leading to suboptimal heat dissipation, thereby preventing timely release of heat from the optical module, which can ultimately severely impact its performance.

### SUMMARY OF THE DISCLOSURE

The objective of the present disclosure is to provide an optical module, which places the heat sink dissipation surface and the electric driving chip on the circuit board on the same side, so as to facilitate transferring all heat to the main dissipation surface, thereby preventing heat accumulation within the optical module. It also addresses the technical issues of suboptimal heat dissipation caused by the heat sink dissipation surface and the electric driving chip not being on the same side in current optical modules. Furthermore, it resolves the technical problem of low utilization of the circuit board caused by carving grooves into it to house the heat sink, silicon optical chip, and light sources, thereby avoiding resource waste.

In order to achieve the aforementioned purpose, one of the embodiments of the present disclosure is to provide an optical module, comprising: a housing, and a circuit board arranged in the housing, with a first surface and a second surface facing away from each other; an electric driving chip arranged on the first surface of the circuit board and connected to the first surface of the circuit board; a silicon optical chip arranged on the first surface of the circuit board and connected to the first surface of the circuit board; a laser arranged on the surface of one side of the silicon optical chip away from the circuit board, the laser emitting a light and transmitting the light to the silicon optical chip; and a light guide device guiding the light emitted by the laser into the silicon optical chip.

Further, the light guide device comprises a first reflective surface and a second reflective surface, such that the light emitted by the laser is directed onto the first reflective surface, reflected by the first reflective surface to the second reflective surface, and then reflected by the second reflective surface to the silicon optical chip.

Further, the light guide device comprises an isosceles right-angle prism, the isosceles right-angle prism has a slant surface and two right-angle surfaces; the two right-angle surfaces form the first reflective surface and the second reflective surface, respectively.

Further, the light guide device is secured to an outer side wall of the silicon optical chip by the slant surface of the isosceles right-angle prism.

Further, the silicon optical chip comprises an input waveguide and an output waveguide, and the light guide device guides a light into the silicon optical chip through the input waveguide.

Further, the optical module comprises a fiber optic assembly arranged above the first surface of the circuit board and optically coupled to the silicon optical chip.

Further, the laser is evenly distributed on one or both sides of the fiber optic assembly.

Further, the laser is arranged parallel to the silicon optical chip, and the laser is located on the side of the silicon optical chip opposite the fiber optic assembly.

Further, a gap is provided between the silicon optical chip and the electric driving chip, and a ratio of a width of the gap to a width of the electric driving chip is between 0.5 and 2.

Further, at least two light guide devices are distributed on both sides of the fiber optic assembly.

The beneficial effects of the present disclosure include providing an optical module by arranging the laser and the silicon optical chip side by side on the same side of the circuit board, with the light guide device positioned corresponding to the laser, guiding the light emitted by the laser into the silicon optical chip. This arrangement places the silicon optical chip, the laser, and the electric driving chip, which generate heat, on the same side of the circuit board, allowing for the placement of a heat dissipation assembly on the same side, facilitating heat dissipation within the optical module and preventing heat accumulation. Additionally, distributing the laser evenly on one or both sides of the fiber optic assembly increases the heat dissipation area, avoiding heat concentration. Moreover, this design does not require excavating a groove on the circuit board for the heat sink, silicon optical chip, and light source assembly, improving circuit board utilization and reducing manufacturing costs.

### BRIEF DESCRIPTION OF THE DRAWINGS

The following description, in conjunction with the accompanying drawings, provides a detailed account of specific embodiments of the present disclosure and illustrates the technical solutions and other beneficial effects of the present disclosure.

FIG. 1 is a schematic diagram of the three-dimensional structure of an optical module in the common technology.

FIG. 2 is a schematic diagram of the cross-sectional structure of an optical module in the common technology.

FIG. 3 is a schematic diagram of the overall structure of an optical module in an assembled state provided by Embodiment 1 of the present disclosure.

FIG. 4 is a schematic diagram of a partial cross-sectional structure of the optical module provided by Embodiment 1 of the present disclosure.

FIG. 5 is a schematic diagram of the working principle of the silicon optical chip provided by Embodiment 1 of the present disclosure.

FIG. 6 is a schematic diagram of the heat dissipation principle of the optical module provided by Embodiment 1 of the present disclosure.

FIG. 7 is a schematic diagram of a partial structure of the optical module provided by Embodiment 2 of the present disclosure.

FIG. 8 is a schematic diagram of a partial structure of the optical module provided by Embodiment 3 of the present disclosure.

Reference numerals in the drawings are as follows.

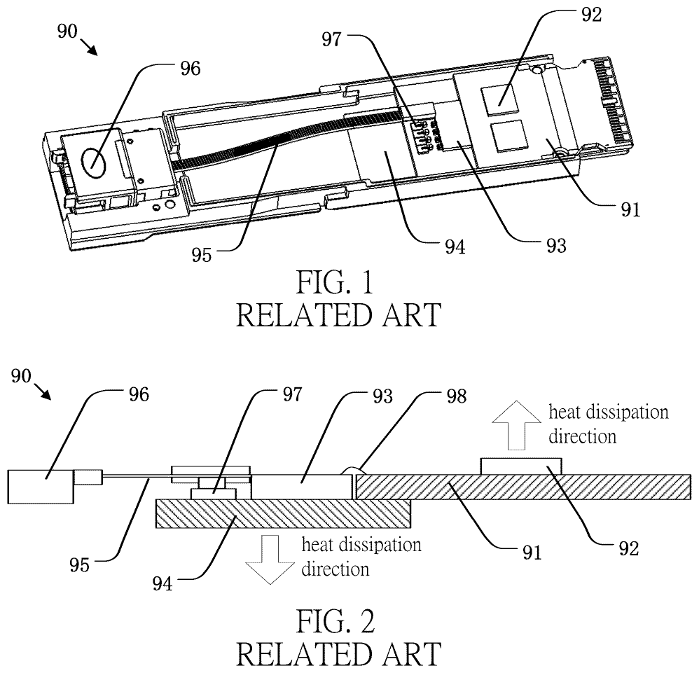

FIGS. 1 to 2: optical module 90, circuit board 91, electric driving chip 92, silicon optical chip 93, heat sink 94, fiber assembly 95, interface part 96, light source 97, gold wire 98;

FIGS. 3 to 8: optical module 100, circuit board 1, electric driving chip 2, silicon optical chip 3, light source assembly 4, fiber assembly 5, heat dissipation assembly 6, solder ball 7, housing 9, light guide device 10, first reflection surface 11, second reflection surface 12, slant surface 13, input waveguide 31, output waveguide 32, modulator 33, wavelength division multiplexer 34, laser 41, lens 42, optical isolator 43, heat dissipation plate 61, fin 62, first surface 101, second surface 102.

### DETAILED DESCRIPTION OF THE EXEMPLARY EMBODIMENTS

The technical solutions provided by the present disclosure are clearly and comprehensively described below with reference to the accompanying drawings. It is evident that the described embodiments represent only a part of the implementations of the present disclosure, not all of them. All other implementations obtained by those skilled in the art, without making inventive efforts based on the embodiments of the present disclosure, are within the scope of protection of the present disclosure.

In the description of the present disclosure, it is necessary to clarify that, unless otherwise specified or defined, the terms “install,” “connect,” and “link” should be broadly understood. For example, they can mean a fixed connection, a detachable connection, or an integrated connection; a mechanical connection, an electrical connection, or a communicative connection; a direct connection, or an indirect connection through an intermediary medium; or communication between or interactions of two components. Those skilled in the art can interpret these terms in the context of the present disclosure according to specific circumstances.

In the present disclosure, unless otherwise explicitly specified and defined, the first feature being “on” or “below” the second feature can mean that the first and second features are in direct contact or that they are not in direct contact but are connected through additional features in between. Additionally, the first feature being “on,” “above,” or “over” the second feature can indicate that the first feature is directly above or diagonally above the second feature, or merely that the first feature's horizontal height is higher than the second feature. The first feature being “under,” “below,” or “beneath” the second feature can indicate that the first feature is directly below or diagonally below the second feature, or merely that the first feature's horizontal height is lower than the second feature.

### Embodiment 1

Specifically, please refer to FIG. 3. Embodiment 1 of the present disclosure provides an optical module 100. In the optical communication, optical module 100 is a key component for converting optical and electrical signals, serving as a critical part of optical communication devices.

Please refer to FIG. 3. The optical module 100 includes a housing 9, and a circuit board 1 arranged within the housing 9, along with an electric driving chip 2, a silicon optical chip 3, a light source assembly 4, a fiber assembly 5, and a light guide device 10. One end of the circuit board 1 features gold fingers, and the circuit board 1 is oriented lengthwise from the electrical port to the optical port of the optical module. The circuit board 1, also known as a Printed Circuit Board (PCB), is primarily made from a copper-clad laminate, which consists of a substrate, copper foil, and an adhesive. The substrate is an insulating layer made from synthetic polymer resin and reinforcing materials. The surface of the substrate is covered with a layer of highly conductive and well-solderable pure copper foil. The copper-clad laminate with copper foil on one side of the substrate is called a single-sided copper-clad board, while the one with copper foil on both sides of the substrate is known as a double-sided copper-clad board. The adhesion of the copper foil to the substrate is accomplished through the adhesive.

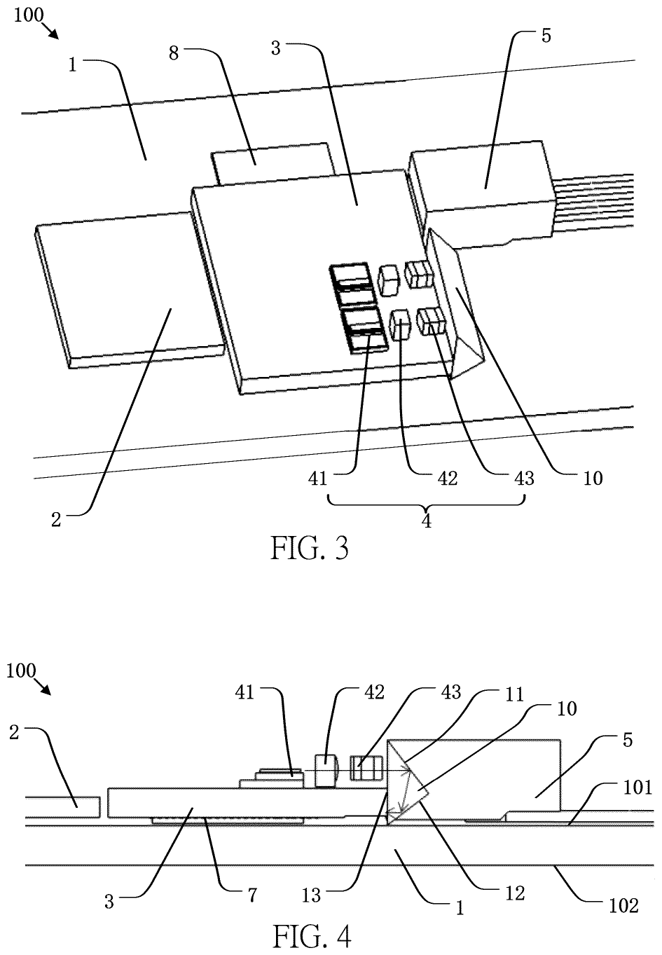

Specifically, as shown in FIG. 4, the circuit board 1 includes a first surface 101 and a second surface 102 facing away from each other. The silicon optical chip 3 and the electric driving chip 2 are connected to the first surface 101 of the circuit board 1, while the fiber assembly 5 is arranged on the first surface. In this embodiment, the first surface 101 is the upper surface of the circuit board 1, and the second surface 102 is the lower surface. The electric driving chip 2 is arranged on the first surface 101 on one side of the circuit board 1, while the silicon optical chip 3 is arranged side by side with the electric driving chip 2 on the same side of the circuit board 1. The light source assembly 4 is arranged on a side of the silicon optical chip 3 away from the circuit board 1, and configured for emitting a signal-free light and transmitting the signal-free light to the silicon optical chip 3. This means that the light source assembly 4 is positioned on the silicon optical chip 3. The fiber assembly 5 is optically coupled to the silicon optical chip 3. The fiber assembly 5 includes a plurality of optical fibers and a plurality of optical connectors at the ends. The plurality of optical connectors are used to couple with the silicon optical chip 3. The silicon optical chip 3, in combination with the electric driving chip 2, selectively allows the light emitted by the light source assembly 4 to pass through, thus forming optical signals that contain data. These optical signals are then transmitted to and through the fiber assembly 5.

As shown in FIG. 3, in the optical module 100, the electric driving chip 2 is correspondingly arranged in the direction of the silicon optical chip 3 extending to connect to the fiber assembly 5, with the fiber assembly 5 connecting to one side of the silicon optical chip 3. The light guide device 10 is arranged corresponding to the light source assembly 4, and directs the light emitted by the light source assembly 4 into the silicon optical chip 3. The silicon optical chip 3 then processes the light and transmits the light to the fiber assembly 5. As shown in FIG. 3, the electric driving chip 2, the silicon optical chip 3, and the fiber assembly 5 are sequentially arranged along the longitudinal direction of the optical module 100 (the direction connecting the optical port and electrical port). The light guide device 10 and the fiber assembly 5 are connected side by side to the same side of the silicon optical chip 3.

Referring to FIGS. 3 and 4, the light source assembly 4 includes a plurality of lasers 41, a plurality of lenses 42, and a plurality of optical isolators 43. The light guide device 10 is a turning prism. The lasers 41 are the primary heat-generating elements. The lasers 41, the lenses 42, and the optical isolators 43 are arranged on the silicon optical chip 3, and the light guide device 10 is arranged on a side of the silicon optical chip 3. Specifically, the plurality of lasers 41 are mounted on the silicon optical chip 3 and configured for emitting light. The lenses 42, the lasers 41, and the optical isolators 43 are arranged in a straight line and mounted on the silicon optical chip 3. The electric driving chip 2 drives the silicon optical chip 3 to work. The light guide device 10 is arranged corresponding to the optical isolator 43 and mounted on the side wall of the silicon optical chip 3. The lasers 41, the lenses 42, the optical isolators 43, and the light guide device 10 are arranged correspondingly, forming a plurality of optical channels.

More specifically, the lenses 42 are installed on the top of the silicon optical chip 3. Each lens 42 faces the emission surface of a corresponding laser 41, with the central axis of each lens 42 aligning with the central axis of the light source of the lasers 41. The optical isolators 43 are also mounted on the top surface of the silicon optical chip 3. Each optical isolator 43 has a light-transmitting face arranged opposite a lens 42.

The light guide device 10 includes a first reflection surface 11 and a second reflection surface 12. The light emitted by the laser 41 illuminates the first reflection surface 11, and after being reflected by the first reflection surface 11, is reflected to the second reflection surface 12. After being reflected by the second reflection surface 12, the light is directed into the silicon optical chip 3. Thus, a light beam emitted by the laser 41 sequentially passes through the lens 42, the optical isolator 43, and the light guide device 10, and is reflected to the sidewall of the silicon optical chip 3 and enters the silicon optical chip 3 to form a light path. Additionally, the light guide device 10 can also be an optical fiber or another component.

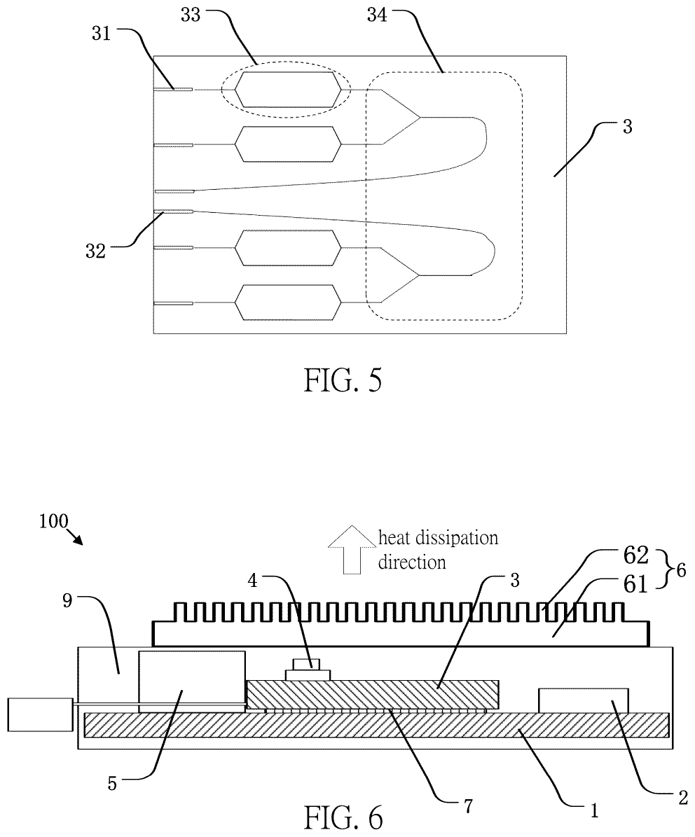

As shown in FIG. 5, the working principle of the silicon optical chip 3 is depicted. The silicon optical chip 3 includes a waveguide, a modulator, a splitter, a detector, a wavelength division multiplexer, a wavelength division demultiplexer, an input/output port, circuits, heating (resistors), and circuit pads. The structure shown in FIG. 5 is simplified. The optical waveguide includes an input waveguide 31 and an output waveguide 32 located on the same side. A light beam enters from the input waveguide 31 and is transmitted in the waveguide (indicated by lines in the figure), and passes through the modulator 33 and the wavelength division multiplexer 34 and then the light beam carrying the signal is output from the output waveguide 32.

In addition, the light guide device 10 is an isosceles right-angle prism. The isosceles right-angle prism includes a slant surface 13 and two right-angle surfaces. The two right-angle surfaces form the first reflection surface 11 and the second reflection surface 12, respectively. Part of the slant surface 13 is fixed to the side wall of the silicon optical chip 3, for example, by gluing the light guide device 10 onto the silicon optical chip 3. The first reflection surface 11 and the second reflection surface 12 are configured to reflect light. The light entry surface and the light exit surface of the light guide device 10 are part of the slant surface 13. After the light condensed by the lens 42 passes through the slant surface 13 (light entry surface) and enters the light guide device 10, a total reflection occurs on the first reflective surface 11 and the second reflective surface 12 in sequence and then is reflected to the side wall surface of the silicon optical chip 3 and emitted through the slant surface 13 (light exit surface) into the corresponding input waveguide.

In this embodiment, a plurality of optical channels formed by the light source assembly 4 are all on the same side of the fiber assembly 5. This helps disperse the heat generated by the light source assembly 4 and avoid heat concentration and aiding in heat dissipation.

The optical module 100 can be an eight-channel module. That is, eight optical channels formed by the light source assembly 4 use 2 or 4 lasers 41, and then are emitted from 8 fiber bundles. In practical applications, the number of optical channels can be adjusted according to actual needs, and the present disclosure does not limit the specific number.

The silicon optical chip 3 and the electric driving chip 2 are arranged side by side. In addition, the concentration of heat sources can be avoided by increasing the distance between the silicon optical chip 3 and the electric driving chip 2. For example, a gap is provided between the silicon optical chip 3 and the electric driving chip 2, and the ratio of the width of the gap to the width of the electric driving chip 3 is 0.5-2. This adjusts the heat distribution.

To avoid heat concentration, the lasers 41 are distributed evenly on the same side of the fiber assembly 5, so as to avoid heat concentration from the lasers 41. In this embodiment, the lasers 41 and the silicon optical chip 3 are arranged side by side on the same side of the circuit board 1, and the light guide device 10 is correspondingly arranged to the lasers 41 to direct the light emitted by the lasers 41 into the silicon optical chip 3, so that the heat-generating silicon optical chip 3, the lasers 41, and the electric driving chip 2 are all on the same side of the circuit board 1, which is beneficial to achieve internal heat dissipation of the optical module and avoid concentrated accumulation of heat inside the optical module.

The distance between the lasers 41 and the edge of the silicon optical chip 3 closer to the fiber assembly 5 is less than the distance between the lasers 41 and the edge of the silicon optical chip 3 closer to the electric driving chip 2. In other words, the position of the lasers 41 on the silicon optical chip 3 is closer to the fiber assembly 5 (or the light guide device 10) than to the electric driving chip 2. This also increases the distance between the lasers 41 and the electric driving chip 2 to prevent heat concentration.

Refer to FIGS. 4 and 6. To reduce costs, the silicon optical chip 3 is electrically connected to the circuit board 1 through solder balls 7, making it suitable for existing soldering techniques and enabling mass production.

Refer to FIG. 6. In this embodiment, the housing 9 is a box, and the circuit board 1, the electric driving chip 2, the silicon optical chip 3, and the light source assembly 4 are contained inside and protected by the housing 9. A heat dissipation pad or a thermal conductive adhesive can be added inside the housing 9 to fix and dissipate heat from the circuit board 1, the electric driving chip 2, the silicon optical chip 3, the laser 41, and other components.

In the embodiment, the optical module 100 further includes a heat dissipation assembly 6, which is thermally connected to the external surface of the housing 9. The heat dissipation assembly 6 includes a heat dissipation plate 61 and at least two fins 62. The heat dissipation plate 61 is thermally connected to the external surface of the housing 9. At least two fins 62 protrude from the surface of the heat dissipation plate 61 away from the housing 9. Notably, the optical module 100 has the heat dissipation assembly 6 only on the housing 9, so that it needs to try to achieve heat dissipation on the same side of the circuit board 1 to avoid heat dissipation on both the upper and lower surfaces of the circuit board 1 and cause the temperature of the circuit board 1 to be too high, and to prevent the temperature of the optoelectronic devices from being too high so as to fail to work. The heat dissipation assembly 6 is set as a heat sink on the housing 9, though the heat dissipation assembly 6 may not be present. In this embodiment, the heat sink 8 can also be integrated into the housing 9. The housing 9 may also be divided into upper and lower parts, with the heat dissipation assembly 6 serving as a heat sink on the upper housing, allowing heat generated by the laser 41 to transfer to the heat sink 8 and then to the upper housing. The heat dissipation assembly 6 then dissipates the heat away. The electric driving chip 2 may also be thermally connected to the housing 9 via a heat pad or thermal paste, allowing the heat generated by the electric driving chip 2 to transfer to the upper housing and then be dissipated by the heat dissipation assembly 6.

### Embodiment 2

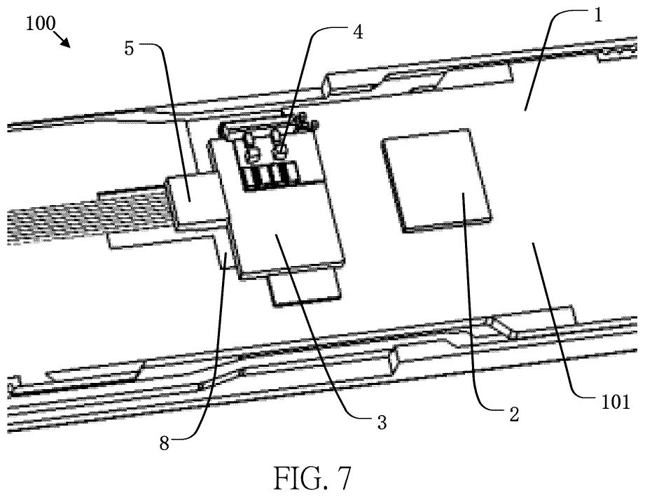

In Embodiment 2, most of the technical features of Embodiment 1 are retained. The difference lies in that, as shown in FIG. 7, in Embodiment 2, the fiber assembly 5 is connected to one side of the rectangular-shaped silicon optical chip 3. The light guide device 10 is positioned on the side adjacent to where the silicon optical chip 3 connects to the fiber assembly 5, unlike in Embodiment 1, where the electric driving chip 2, the silicon optical chip 3, and the fiber assembly 5 are arranged sequentially along the longitudinal direction of the optical module 100. In this layout, the light guide device 10 and the fiber assembly 5 are aligned and connected to the same side of the silicon optical chip 3. This arrangement utilizes the side space of the silicon optical chip 3 to compress the extension length of the fiber assembly 5, thereby reducing the overall length in the extension direction of the fiber assembly 5.

The difference between Embodiment 2 and Embodiment 1 is in the arrangement of the light guide device 10 and the light source assembly 4 on the silicon optical chip 3. To avoid heat concentration, the lasers 41 are evenly distributed on the same side of the fiber assembly 5 to prevent heat concentration from the lasers 41. In Embodiment 2, the laser 41 and the silicon optical chip 3 are also arranged side by side on the same side of the circuit board 1. Moreover, the light guide device 10 is positioned corresponding to the laser 41 and directs the light emitted by the laser 41 into the silicon optical chip 3. As a result, the heat-generating silicon optical chip 3, the laser 41, and the electric driving chip 2 are all located on the same side of the circuit board 1. This facilitates cooling from the same side of the circuit board and helps dissipate heat from inside the optical module and prevent heat from accumulating within the module.

### Embodiment 3

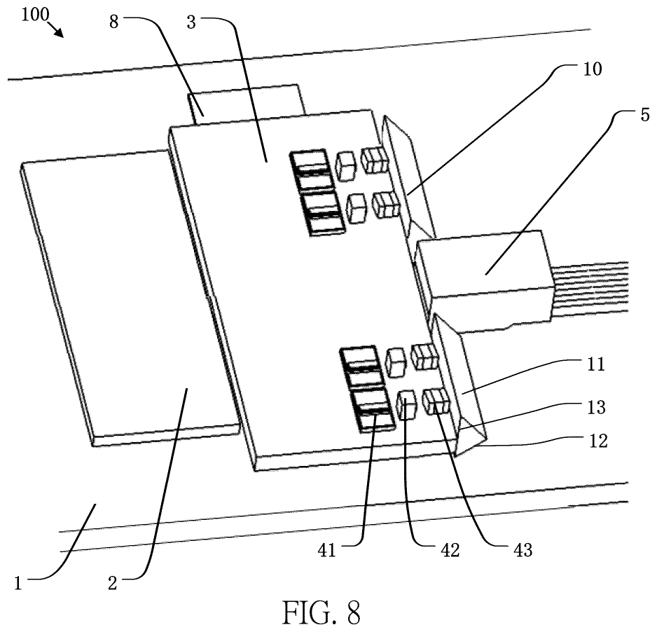

Embodiment 3 includes most of the features from Embodiment 1, the difference lies in the arrangement shown in FIG. 8. In Embodiment 3, to avoid heat concentration, the lasers 41 are evenly distributed on both sides of the fiber assembly 5, instead of on just one side. In Embodiment 3, a plurality of optical channels formed by the light source assembly 4 are evenly distributed on both sides of the fiber assembly 5. Correspondingly, the light guide device 10 corresponding to the light source assembly 4 is also distributed on both sides of the fiber assembly 5. This Embodiment further places heat-generating elements on the same side of the circuit board 1 in a dispersed manner, so as to avoid heat concentration and allow for an increased number of optical channels.

Referring to FIG. 8, this Embodiment also places the silicon optical chip 3 and the electric driving chip 2 side by side on the same side of the circuit board 1, and the light source assembly 4 is arranged on the side of the silicon optical chip 3 that faces away from the circuit board 1. In this way, the heat-generating silicon optical chip 3, the light source assembly 4, and the electric driving chip 2 are located on the same side of the circuit board 1, so as to allow the heat dissipation assembly 6 to be set on the same side, thereby facilitating heat dissipation within the optical module and preventing the accumulation of heat within the module. Additionally, this design eliminates the need to provide a groove in the circuit board 1 to house the heat sink, the silicon optical chip 3, and the light source assembly 4, so as to improve the utilization rate of the circuit board 1 and reduce production costs.

It is understood that in FIG. 3 and FIG. 8, the laser 41 and the silicon optical chip 3 are arranged side by side, with the laser 41 positioned on the side of the silicon optical chip 3 opposite to the fiber assembly 5, meaning that the laser 41 is situated on the same side of the silicon optical chip 3 that faces the fiber assembly 5.

The beneficial effect of the present disclosure is an optical module is provided, where the laser is arranged side by side with the silicon optical chip on the same side of the circuit board, and the light guide device is correspondingly set to guide the light emitted by the laser into the silicon optical chip. Consequently, the heat-generating silicon optical chip, the laser, and the electric driving chip are all on the same side of the circuit board, so as to allow a heat dissipation assembly to be installed on that side. This arrangement facilitates heat dissipation in the optical module and prevents heat accumulation. Moreover, distributing the laser evenly on one or both sides of the fiber assembly increases the heat dissipation area and prevents heat concentration. Additionally, this structure does not require grooves to be provided in the circuit board for a heat sink, the silicon optical chip, or the light source assembly, which improves the utilization rate of the circuit board and reduces production costs.

In the aforementioned embodiments, the description of each embodiment has its own focus. Any part not described in detail in one embodiment can be referred to in other embodiments.

The detailed description provided for one optical module example in the present disclosure serves to explain its principle and implementation. The explanations are meant to assist in understanding the technical solutions and core ideas of the present disclosure. It is understood by those skilled in the art that the technical solutions of these embodiments can be modified or some technical features replaced with equivalents, without changing the essence of the technical solutions presented in these embodiments.

1. An optical module, comprising:
a housing, and a circuit board arranged in the housing, including a first surface and a second surface facing away from each other;
an electric driving chip arranged on the first surface of the circuit board and connected to the first surface of the circuit board;
a silicon optical chip arranged on the first surface of the circuit board and connected to the first surface of the circuit board;
a laser arranged on a surface of the silicon optical chip away from the circuit board, the laser emitting a light and transmitting the light to the silicon optical chip; and
a light guide device guiding the light emitted by the laser into the silicon optical chip.

2. The optical module according to claim 1, wherein the light guide device comprises a first reflective surface and a second reflective surface, the light emitted by the laser is directed onto the first reflective surface, reflected by the first reflective surface to the second reflective surface, and then reflected by the second reflective surface to the silicon optical chip.

3. The optical module according to claim 2, wherein the light guide device comprises an isosceles right-angle prism, the isosceles right-angle prism has a slant surface and two right-angle surfaces; the two right-angle surfaces form the first reflective surface and the second reflective surface, respectively.

4. The optical module according to claim 3, wherein the light guide device is secured to an outer side wall of the silicon optical chip by the slant surface of the isosceles right-angle prism.

5. The optical module according to claim 1, wherein the silicon optical chip comprises an input waveguide and an output waveguide, and the light guide device guides a light into the silicon optical chip through the input waveguide.

6. The optical module according to claim 1, further comprising: a fiber optic assembly arranged above the first surface of the circuit board and optically coupled to the silicon optical chip.

7. The optical module according to claim 6, wherein the laser is evenly distributed on one or both sides of the fiber optic assembly.

8. The optical module according to claim 6, wherein the laser is arranged parallel to the silicon optical chip, and the laser is located on the side of the silicon optical chip opposite the fiber optic assembly.

9. The optical module according to claim 1, wherein a gap is provided between the silicon optical chip and the electric driving chip, and a ratio of a width of the gap to a width of the electric driving chip is between 0.5 and 2.

10. The optical module according to claim 6, wherein at least two light guide devices are distributed on both sides of the fiber optic assembly.
